(19) United States
(12) Patent Application Publication
(10) Pub. No.: US 2026/0261013 A1
(43) Pub. Date: Sep. 3, 2026

(54) ULTRAHIGH STRENGTH SEPARATORS AND PREPARATION METHODS THEREOF

(71) Applicant: SHANGHAI ENERGY NEW MATERIALS TECHNOLOGY CO., LTD., Shanghai (CN)

(72) Inventors: Shaobo YU, Shanghai (CN); Kun PENG, Shanghai (CN); Zhi ZHUANG, Shanghai (CN); Xiawei QI, Shanghai (CN); Yuhong CAI, Shanghai (CN); Kun LI, Shanghai (CN); Xiaoming GONG, Shanghai (CN); Yue CHENG, Shanghai (CN)

(21) Appl. No.: 18/879,730

(22) PCT Filed: Apr. 27, 2023
(86) PCT No.: PCT/CN2023/091225

§ 371 Date: Dec. 27, 2024

(30) Foreign Application Priority Data
Jun. 29, 2022 (CN) 202210757403.5

(51) Int. Cl. H01M 50/494; H01M 10/0525; H01M 50/403; H01M 50/417; H01M 50/491

(52) U.S. Cl. CPC H01M 50/494; H01M 50/403; H01M 50/417; H01M 50/491; H01M 10/0525

(57) ABSTRACT

An ultrahigh strength separator and the preparation method thereof. The method comprises: (1) mixing and heating a composition comprising a polyolefin resin, an antioxidant, and a pore-forming agent to form a molten state mixture, extruding the mixture through a die, and cooling it to form casting piece; (2) performing a first machine direction stretching and a first transverse direction stretching on the casting piece sequentially to obtain a stretched film; (3) performing a second machine direction stretching on the stretched film; (4) performing a second transverse direction stretching; (5) performing extraction, a third transverse stretching, and heat setting sequentially to obtain the ultrahigh strength separator. The separator prepared by the process of the present disclosure is greatly improved in tensile strength in the machine and transverse stretching directions, and its puncture strength can also be much higher than that of other separators of the same thickness. When the separator disclosed herein is used in a lithium-ion battery, it can provide better isolation and protection for the positive and negative electrodes of the battery when the battery is subjected to external shocks, so as to avoid the risk of short circuit caused by separator rupture, and can improve the safety performance of lithium-ion batteries.

### TECHNICAL FIELD

The present disclosure relates to the field of lithium-ion battery separators, and specifically relates to an ultrahigh strength separator and its preparation method.

### BACKGROUND ART

Lithium-ion batteries have been widely used in the fields of electronic devices, new energy vehicles, and wind power energy storage in recent years; lithium-ion battery separator is an important part of the lithium-ion battery; the separator plays the role of separating positive and negative electrodes to prevent short circuit and to allow the electrolyte solution to pass through so as to generate electric current; the main properties of the separator include porosity, air permeability, tensile strength, puncture strength, shutdown temperature, etc. The performance of the separator directly affects the capacity, cycle performance, and safety performance of the batteries. Therefore, improving the performance of the separator is of great significance to the performance of lithium-ion batteries.

At present, the main process of the most common wet process for separator preparation is: Extruder→Die→CAST→Machine Direction (MD)→Transverse Direction Stretching 1 (TD1)→Extraction→Transverse Direction Stretching 2 (TD2)→Heat setting. This process is mature and controllable, and is a common process for preparing conventional base film; but due to the limitation of equipment footprint and the process, the stretching ratio of this traditional process in Machine Direction (hereinafter abbreviated as “MD”, which is the casting direction) and the Transverse Direction (hereinafter abbreviated as “TD”, which is perpendicular to the casting direction) is subject to certain restrictions, usually below 15 times, which limits the tensile strength and puncture strength of the separator. In recent years, safety issues have become common to lithium-ion batteries, and more and more attention has been paid to the studies on the safety of lithium-ion batteries; for some separators, the requirements for tensile strength and puncture strength become increasingly higher, and it is sometimes required to increase the puncture strength of the separators while minimizing the thickness of the separators.

Therefore, it is desirable to develop an ultra-thin separator with ultrahigh strength and puncture strength to break through the limitations of the mechanical properties of traditional separators.

### CONTENTS OF THE DISCLOSURE

Due to the limitation of the equipment and the single-stage MD+TD stretching process, the current mainstream separator stretching technology cannot achieve ultrahigh ratio stretching. The present disclosure is thus proposed herewith to overcome the drawbacks of low stretching ratio in the traditional process, and to prepare an ultrahigh strength polyethylene separator that can be mass-produced quickly.

In order to achieve the above purposes, the technical solutions of the present disclosure are implemented as the follows:

In one perspective, the present disclosure provides an ultrahigh strength separator, of which the thickness ranges from 4 μm to 8 μm, the transverse-direction tensile strength is greater than 4000 kgf/cm², the machine-direction tensile strength is greater than 4000 kgf/cm², and the puncture strength per thickness of the ultrahigh strength separator is no less than 100 gf/μm.

Further, in some embodiments, the transverse-direction tensile strength of the ultrahigh strength separator ranges from 4500 kgf/cm² to 7000 kgf/cm², the machine-direction tensile strength of the ultrahigh strength separator ranges from 4500 kgf/cm² to 7000 kgf/cm², and the puncture strength per thickness of the ultrahigh strength separator ranges from 100 gf/μm to 200 gf/μm.

Further, in some embodiments, the porosity of the ultrahigh strength separator ranges from 30% to 50%, and the air permeability of the ultrahigh strength separator ranges from 50 s/100 ml to 300 s/100 ml.

In another perspective, the present disclosure provides a method for preparation of an ultrahigh strength separator, comprising:
(1) mixing and heating a composition comprising a polyolefin resin, an antioxidant, and a pore-forming agent to form a molten state mixture, extruding the mixture through a die, and cooling it to form a casting piece;
(2) performing a first machine direction stretching and a first transverse direction stretching on the casting piece sequentially to obtain a stretched film;
(3) performing a second machine direction stretching on the stretched film;
(4) performing a second transverse direction stretching;
(5) performing extraction, a third transverse stretching, and heat setting sequentially to obtain the ultrahigh strength separator.

In some embodiments, the polyolefin resin in step (1) is a high-molecular-weight polyethylene, of which the molecular weight ranges from 600,000-2,000,000.

In some embodiments, the antioxidant in step (1) is one or more selected from amines, sulfur-containing compounds, nitrogen-containing compounds, phosphorus-containing compounds, and organic metal salts.

In some embodiments, the pore-forming agent in step (1) is one or more selected from white oil, paraffin oil, and polyethylene glycol.

Further, in some embodiments, for both the first machine direction stretching and the first transverse direction stretching in step (2), the stretching temperature ranges from 60 [symbol] to 150 [symbol] , and the stretching ratio ranges from 3 to 15 times.

Further, in some embodiments, for the second machine direction stretching in step (3), the stretching temperature ranges from 60 [symbol] to 140 [symbol] , and the stretching ratio range from 2 to 10 times.

Further, in some embodiments, for the second transverse direction stretching in step (4), the stretching temperature ranges from 90 [symbol] to 140 [symbol] , and the stretching ratio ranges from 2 to 10 times.

Further, in some embodiments, for the third transverse direction stretching in step 5, the stretching temperature ranges from 100 [symbol] to 150 [symbol] , and the stretching ratio ranges from 1.1 to 2 times.

Further, in some embodiments, the temperature of heat setting in step (5) ranges from 110 [symbol] to 150 [symbol] .

In another perspective, the present disclosure provides a method for preparation of an ultrahigh strength separator, comprising:
(1) mixing and heating a composition comprising a polyolefin resin, an antioxidant, and a pore-forming agent to form a molten state mixture, extruding the mixture through a die, and cooling it to form a casting piece;
(2) performing a first machine direction stretching and a first transverse direction stretching on the casting piece sequentially to obtain a stretched film;
(3) performing a second machine direction stretching on the stretched film;
(4) performing a synchronous biaxial stretching;
(5) performing extraction, a third transverse stretching, and heat setting sequentially to obtain the ultrahigh strength separator.

In some embodiments, the polyolefin resin in step (1) is a high-molecular-weight polyethylene, of which the molecular weight ranges from 600,000 to 2,000,000.

In some embodiments, the antioxidant in step (1) is one or more selected from nitrogen-containing compounds such as amines, sulfur-containing compounds, phosphorus-containing compounds, and organic metal salts. In some embodiments, the nitrogen-containing compounds may include but not limited to diaryl secondary amines, p-phenylenediamine derivatives, and aldehyde amines; the sulfur-containing compounds may include but not limited to didodecyl thiodipropionate and molybdenum dialkyldithiocarbamate; the phosphorus-containing compounds may include but not limited to zinc dialkyl dithiophosphate, etc.; and the organic metal salts may include but not limited to molybdate, etc.

In some embodiments, the pore-forming agent in step (1) is one or more selected from white oil, paraffin oil, and polyethylene glycol.

Further, in some embodiments, for both the first machine direction stretching and the first transverse direction stretching in step (2), the stretching temperature ranges from 60 [symbol] to 150 [symbol] , and the stretching ratio ranges from 3 to 15 times.

Further, in some embodiments, for the second machine direction stretching in step (3), the stretching temperature ranges from 60 [symbol] to 140 [symbol] , and the stretching ratio ranges from 2 to 10 times.

Further, in some embodiments, for the synchronous biaxial stretching in step (4), the stretching temperature ranges from 90 [symbol] to 140 [symbol] , and the stretching ratio ranges from 1.5×1.5 to 12×12 times.

Further, in some embodiments, for the third transverse direction stretching in step (5), the stretching temperature ranges from 100 [symbol] to 150 [symbol] , and the stretching ratio ranges from 1.1 to 2 times.

Further, in some embodiments, the temperature of heat setting in step (5) ranges from 110 [symbol] to 150 [symbol] .

As disclosed herein, the present disclosure provides the method of preparation of a separator, including a second machine direction stretching together with a second transverse direction stretching or a synchronous biaxial stretching before the extraction operation to increase the stretching ratio of machine direction stretching and transverse direction stretching through cascade stretching. Also, the method disclosed herein, including the second machine direction stretching before the second transverse direction stretching or synchronous biaxial stretching may greatly reduce the width of the film, and thereby eliminating the step of separator slitting and improving the preparation efficiency and equipment utilization. The separator prepared by the process of the present disclosure is greatly improved in tensile strength in the machine and transverse stretching directions, and its puncture strength can also be much higher than that of other separators of the same thickness. When the separator disclosed herein is used in a lithium-ion battery, it can provide better isolation and protection for the positive and negative electrodes of the battery when the battery is subjected to external impact, so as to avoid the risk of short circuit caused by separator rupture, and improve the safety performance of lithium-ion batteries.

### DESCRIPTION OF THE DRAWINGS

FIG. 1 is a flow chart of a wet process for separator preparation in the prior art;

FIG. 2 is a flow chart of a wet process for separator preparation according to the present disclosure;

FIG. 3 is a flow chart of a second wet process for separator preparation according to the present disclosure;

Legends in the figures: S1—Extrusion; S2—Cooling and piece forming; S3—MD1; S4—TD1; S5—MD2; S6—TD2; S7—SBS (i.e., synchronous biaxial stretching); S8—Extraction; S9—TD3; S10—Heat setting.

### SPECIFIC EMBODIMENTS

The specific embodiments of the present disclosure are described in detail below. It should be understood that the specific embodiments described herein are only used to illustrate and explain the present disclosure, but not to limit the present disclosure. The endpoints of ranges and any values disclosed herein are not limited to the precise ranges or values, which should be understood to contain values proximate to those ranges or values. For ranges of values, the endpoint values of each range, the endpoint values of each range and the individual point values, and the individual point values can be combined with each other to yield one or more new ranges of values, which shall be considered as specifically disclosed herein.

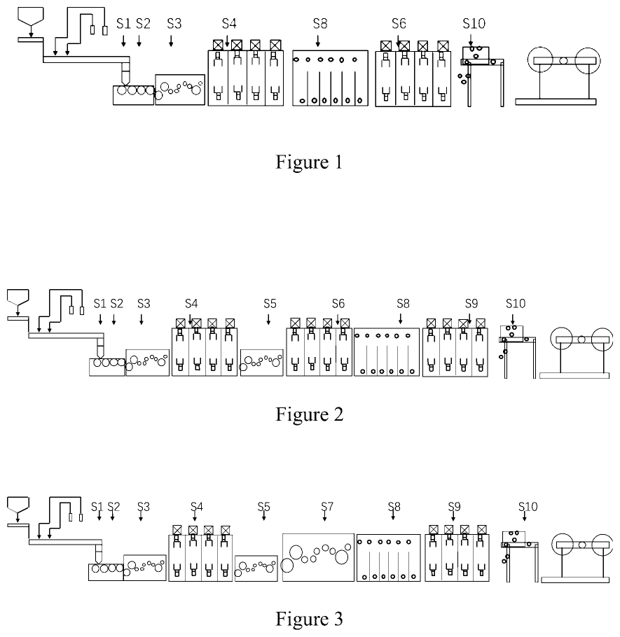

As shown in FIG. 1, the main flow of the wet process for separator preparation in the prior art is: S1 Extrusion→S2 Cooling and piece forming→S3 MD1→S4 TD1→S8 Extraction→S6 TD2→S10 Heat setting.

As shown in FIG. 2, an ultrahigh strength separator preparation method is provided, comprising:
(1) premixing dry powders of a high-molecular-wight polyethylene and an antioxidant, then adding the premixed mixture into the twin-screw extruder together with an organic pore-forming agent, extruding the mixture through a die in S1, and then cooling it through chill rolls to form a casting piece in S2;
(2) performing S3 MD1 and S4 TD1 on the casting piece sequentially to obtain stretched film;
(3) performing S5 MD2 on the stretched film;
(4) performing S6 TD2;
(5) extracting the organic pore-forming agent in the separator by using an extractant in S8, and then performing S9 TD3 stretching and S10 heat setting to obtain the ultrahigh strength separator.

Further, in some embodiments, the extrusion rate in the die extrusion ranges from 60 kg/h to 350 kg/h, and the extrusion temperature ranges from 150 [symbol] to 250 [symbol] .

When the extrusion rate and/or the extrusion temperature becomes too high or too low, it may easily lead to melt fracture or excessive casting defects; the morphology of the casting piece plays an important role in maintaining high-ratio stretching, and hence if the casting piece contains many defects, it may easily lead to the rupture of the separator during the stretching process.

Further, in some embodiments, the molecular weight of the high-molecular-weight polyethylene in step (1) ranges from 600,000 to 2,000,000; in step (1), the concentration of the antioxidant is expressed as “in parts by mass,” for example, the amount of the high-molecular-weight polyethylene is 100 parts by mass, the amount of the antioxidant ranges, for example, from 0.1 to 1 part by mass, and the amount of the organic pore-forming agent ranges, for example, from 233 to 400 parts by mass. In some embodiments, the amount of the high-molecular-weight polyethylene is 100 parts by mass, the amount of the antioxidant ranges from 0.1 to 1 part by mass, and the amount of the organic pore-forming agent ranges from 233 to 360 parts by mass. In some embodiments, the amount of the high-molecular-weight polyethylene is 100 parts by mass, the amount of the antioxidant ranges from 0.2 to 0.5 part by mass, and the amount of the organic pore-forming agent ranges from 250 to 360 parts by mass.

Further, in some embodiments, the antioxidant in step (1) is one or more selected from amines, sulfur-containing compounds, nitrogen-containing compounds, phosphorus-containing compounds, and organic metal salts.

Further, in some embodiments, the pore-forming agent in step (1) is one or more selected from white oil, paraffin oil, and polyethylene glycol.

Further, in some embodiments, for both S3 MD1 and S4 TD1 in step 2, the stretching temperature ranges from 60 [symbol] to 150 [symbol] , preferably from 60 [symbol] to 125 [symbol] , such as from 60 [symbol] to 120 [symbol] ; and the stretching ratio ranges from 3 to 15 times, preferably from 8 to 15 times, such as from 8 to 10 times.

Further, in some embodiments, for S5 MD2 in step (3), the stretching temperature ranges from 60 [symbol] to 140 [symbol] , preferably from 60 [symbol] to 130 [symbol] , and the stretching ratio ranges from 2 to 10 times, preferably from 2.5 to 10 times.

After S4 TD1 stretching, the resulting film may become much wider, and hence the width of the film is then greatly reduced by S5 MD2 stretching, which eliminates the step of separator slitting, improves the production efficiency and equipment utilization, increases the stretching ratio of the film, and facilitates subsequent stretching.

Further, in some embodiments, for S6 TD2 in step (4), the stretching temperature ranges from 90 [symbol] to 140 [symbol] , preferably from 90 [symbol] to 130 [symbol] , and the stretching ratio ranges from 2 to 10 times, preferably from 3 to 10 times.

Here, S6 TD2 stretching is performed on the film with reduced width, so that the stretching ratio of the film is further increased.

Further, the stretching ratio of the S3 MD1 is set as “a”, the stretching ratio of the S4 TD1 is set as “b”, the stretching ratio of the S5 MD2 is set as “c”, and the stretching ratio of the S6 TD2 is set as is “d”, and the product of “a” and “c” is defined as “e,” i.e., a×c=e, similarly, the product of “b” and “d” is defined as “f,” i.e., b×d=f. The values of “e” and “f” disclosed herein, in some embodiments, independently range from 15 to 150, preferably from 25 to 150, such as from 30 to 150, further such as from 100 to 150.

As disclosed herein, a S5 MD2 operation together with a S6 TD2 operation are added before S8 extraction, and the stretching ratio in MD and TD is increased by cascade stretching, so that the total stretching ratios “e” and “f” in MD and TD can reach a value ranging from 15 to 150 times, and the area stretching ratio can thus reach a value ranging from 225 to 22500 times. The separator prepared by the process of the present disclosure is greatly improved in tensile strength in MD and TD, and its puncture strength can also be much higher than that of other separators of the same thickness.

Further, in some embodiments, for S9 TD3 in step (5), the stretching temperature ranges from 100° C. to 150° C., preferably from 100° C. to 130 [symbol] , and the stretching ratio ranges from 1.1 to 2 times, preferably from 1.2 to 2 times.

Further, in some embodiments, the temperature of S10 heat setting in step (5) ranges from 110° C. to 150 [symbol] , preferably from 110° C. to 135 [symbol] .

As shown in FIG. 3, a method for preparation of an ultrahigh strength separator is provided, comprising:
(1) premixing dry powders of a high-molecular-weight polyethylene and an antioxidant, then adding the premixed mixture into the twin-screw extruder together with an organic pore-forming agent, extruding the mixture through a die in S1, and then cooling it through chill rolls to form a casting piece in S2;
(2) performing S3 MD1 and S4 TD1 on the casting piece sequentially to obtain a stretched film;
(3) performing S5 MD2 on the stretched film;
(4) performing S7 SBS;
(5) extracting the organic pore-forming agent in the separator by using an extractant in S8, and then perform S9 TD3 stretching and S10 heat setting to obtain the ultrahigh strength separator.

In some embodiments, the extrusion rate in the die extrusion ranges from 60 kg/h to 350 kg/h, and the extrusion temperature ranges from 150 [symbol] to 250 [symbol] .

When the extrusion rate and/or the extrusion temperature becomes too high or too low, it may easily lead to melt fracture or excessive casting defects; the morphology of the casting piece plays an important role in maintaining high-ratio stretching, and thus if the casting piece contains many defects, it may easily lead to the rupture of the separator during the stretching process.

Further, in some embodiments, the molecular weight of the high-molecular-weight polyethylene in step (1) ranges from 600,000 to 2,000,000; the concentration of the ingredients is expressed as “in parts by mass,” for example, the amount of the high-molecular-weight polyethylene is 100 parts by mass, the amount of the antioxidant ranges, for example, from 0.1 to 1 part by mass, and the amount of the organic pore-forming agent ranges, for example, from 233 to 400 parts by mass. In some embodiments, the amount of the high-molecular-weight polyethylene is 100 parts by mass, the amount of the antioxidant ranges from 0.1 to 1 part by mass, and the amount of the organic pore-forming agent ranges from 233 to 360 parts by mass. In some embodiments, the amount of the high-molecular-weight polyethylene is 100 parts by mass, the amount of the antioxidant ranges from 0.2 to 0.5 part by mass, and the amount of the organic pore-forming agent ranges from 250 to 360 parts by mass.

Further, in some embodiments, the antioxidant in step (1) is one or more selected from amines, sulfur-containing compounds, nitrogen-containing compounds, phosphorus-containing compounds, and organic metal salts.

Further, in some embodiments, the pore-forming agent in step (1) is one or more selected from white oil, paraffin oil, and polyethylene glycol.

Further, in some embodiments, for both S3 MD1 and S4 TD1 in step (2), the stretching temperature ranges from 60 [symbol] to 150 [symbol] , preferably from 60 [symbol] to 125 [symbol] , such as from 60 [symbol] to 120 [symbol] , and the stretching ratio ranges from 3 to 15 times, preferably from 8 to 15 times, such as from 8 to 10 times.

Further, in some embodiments, for S5 MD2 in step (3), the stretching temperature ranges from 60 [symbol] to 140 [symbol] , preferably from 60 [symbol] to 130 [symbol] , and the stretching ratio ranges from 2 to 10 times, preferably from 2.5 to 10 times.

After S4 TD1 stretching, the film may become much wider, and hence the width of the film is then greatly reduced by S5 MD2 stretching, which eliminates the step of separator slitting, improves the production efficiency and equipment utilization, increases the stretching ratio of the film, and facilitates subsequent stretching.

Further, in some embodiments, for S7 SBS in step (4), the stretching temperature ranges from 90 [symbol] to 140 [symbol] , and the stretching ratio ranges from 1.5×1.5 to 12×12 times, preferably from 3×3 to 12×12 times, such as from 5×5 to 12×12 times, further such as from 8×8 to 12×12 times.

S7 SBS stretching is performed on the film with reduced width, so that the stretching ratio of the film is further increased.

Further, the stretching ratio of the S3 MD1 is set as “a”, the stretching ratio of the S4 TD1 is set as “b”, the stretching ratio of the S5 MD2 is set as “c”, and the stretching ratio of the S7 SBS in any direction is set as is “g”, and the product of “a,” “c,” and “g” is defined as “h,” i.e., a>>g h; similarly, the product of “b” and “g” is defined as “k,” i.e., b>g=k. The values of “h” and “k” are, independently, preferably ranging from 15 to 150, more preferably from 30 to 150, such as from 50 to 150, from 64 to 150, from 75 to 150, from 100 to 150, from 125 to 150, or from 128 to 150.

As disclosed herein, a S5 MD2 operation together with a S7 SBS operation are added before S8 extraction, and the stretching ratio in MD and TD is increased by cascade stretching, so that the total stretching ratios “h” and “k” in MD and TD can reach a value ranging, for example, from 15 to 150 times, and hence the area stretching ratio can reach a value ranging, for example, from 225 to 22500 times. The separator prepared by the process of the present disclosure is greatly improved in tensile strength in MD and TD, and its puncture strength can also be much higher than that of other separators of the same thickness.

Further, in some embodiments, for S9 TD3 in step (5), the stretching temperature ranges from 100 [symbol] to 150 [symbol] , preferably from 100 [symbol] to 130 [symbol] , and the stretching ratio ranges from 1.1 to 2 times, preferably from 1.2 to 2 times.

Further, in some embodiments, the temperature of S10 heat setting in step (5) ranges from 110 [symbol] to 150 [symbol] , preferably from 110 [symbol] to 135 [symbol] .

The ultrahigh strength separator obtained by any one of the above-mentioned preparation methods of the present disclosure may have a thickness ranging, for example, from 3.7 μm to 8 μm, preferably from 4 μm to 6 μm. In some embodiments, the transverse-direction tensile strength of the separator disclosed herein is greater than 4000 kgf/cm², preferably ranging from 4500 kgf/cm² to 7000 kgf/cm², such as from 5000 kgf/cm² to 7000 kgf/cm², from 5500 kgf/cm² to 7000 kgf/cm², from 5800 kgf/cm² to 7000 kgf/cm², from 6100 kgf/cm² to 7000 kgf/cm², or from 6500 kgf/cm² to 7000 kgf/cm². In some embodiments, the machine-direction tensile strength of the separator disclosed herein is greater than 4000 kgf/cm², preferably ranging from 5000 kgf/cm² to 7000 kgf/cm², such as from 5600 kgf/cm² to 7000 kgf/cm², from 6200 kgf/cm² to 7000 kgf/cm², from 6500 kgf/cm² to 7000 kgf/cm², or from 6800 kgf/cm² to 7000 kgf/cm². In some embodiments, the puncture strength per thickness of the separator disclosed herein is no less than 100 gf/μm, preferably ranging from 100 gf/μm to 200 gf/μm, such as from 120 gf/μm to 200 gf/μm, from 130 gf/μm to 200 gf/μm, from 100 gf/μm to 190 gf/μm, from 120 gf/μm to 190 gf/μm, or from 130 gf/μm to 190 gf/μm. In some embodiments, the porosity of the separator disclosed herein ranges from 30% to 50%, and the air permeability of the separator disclosed herein ranges from 50 s/100 ml to 300 s/100 ml.

In order to further understand the present disclosure, the technical solutions provided by the present disclosure are described in detail below with reference to examples.

In the following examples and comparative examples, film performance or parameter testing is performed according to the following methods:

### 1. Thickness

The thickness is measured according to GB/T6672-2001 Standard, and tested with C1216 thickness gauge: sampling the periphery of the prepared base film, cutting out 40 mm×60 mm samples, and testing them at room temperature.

### 2. Puncture Strength

The puncture strength is measured according to ASTM D3736 Standard, and tested with KES-G5 manual compression testing machine: cutting out 40 mm×60 mm sample pieces and testing them at room temperature, providing that the test speed is 0.2 cm/s, and the stroke is 20 mm.

### 3. MD Tensile Strength

The MD tensile strength is measured according to GB/T6672-2001 Standard, and tested with SHIMANZU (AGS-X10KN) tensile machine: cutting out 15 mm×15 mm sample pieces, and testing them at room temperature, providing that the test speed is 50 mm/min, and the test gauge length is 10 mm.

### 4. TD Tensile Strength

The TD tensile strength is measured according to GB/T6672-2001 Standard, and tested with SHIMANZU (AGS-X10KN) tensile machine: cutting out 15 mm×15 mm sample pieces, and testing them at room temperature, providing that the test speed is 50 mm/min, and the test gauge length is 10 mm.

### EXAMPLE 1

100 parts of high-molecular-weight polyethylene (average molecular weight 600,000) and 0.1 part of antioxidant were blended and stirred into a mixture; then the mixture was poured into the feed bin of an extruder and 360 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were sequentially performed on the casting piece, wherein the stretching ratio was both 10 times, the stretching temperature of S3 MD1 was 120 [symbol] , and the stretching temperature of S4 TD1 was 125 [symbol] .

S5 MD2 stretching was performed on the stretched separator, with a stretching ratio of 2.5 times and a stretching temperature of 130 [symbol] , and then S6 TD2 stretching was performed, with a stretching ratio of 3 times and a stretching temperature of 130 [symbol] .

Dichloromethane was used as the extractant to extract the white oil by stages in S8, with the extraction time of 30 min; and S9 TD3 stretching was performed on the separator after extraction, with a stretching ratio of 1.2 times, and a stretching temperature of 130 [symbol] .

S10 heat setting was performed on the separator stretched in S9 TD3, with a heat setting temperature of 135 [symbol] , to obtain an ultrahigh strength polyethylene separator.

### COMPARATIVE EXAMPLE 1

The blending of the same raw materials and the S1 extrusion were performed by the same steps as in Example 1; after S2 piece forming, only S3 MD1 and S4 TD1 stretching at the same temperature and stretching ratio were performed; and then S8 extraction under the same conditions were conducted; after extraction, S6 TD2 stretching at the same temperature and stretching ratio as those of S9 TD3 in Example 1 was performed; and then S10 heat setting was performed at the same temperature and time as those in Example 1 to obtain a comparative sample.

The test results of the separator products prepared in Example 1 and Comparative Example 1 are as follows:

| | Example 1 | Comparative Example 1 |
|---|---|---|
| Thickness (μm) | 5.8 | 6.7 |
| Total puncture strength (gf) | 622 | 425 |
| Puncture strength/thickness (gf/μm) | 107.2 | 63.4 |
| MD tensile strength (kgf/cm²) | 5600 | 3300 |
| TD tensile strength (kgf/cm²) | 5850 | 3450 |

### EXAMPLE 2

100 parts of high-molecular-weight polyethylene (average molecular weight 600,000) and 0.5 part of antioxidant were blended and stirred into a mixture; then the mixture was poured into the feed bin of an extruder and 360 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were performed sequentially on the casting piece, in which the stretching ratio was both 10 times, the stretching temperature of S3 MD1 was 120 [symbol] , and the stretching temperature of S4 TD1 was 125 [symbol] .

S5 MD2 stretching was performed on the stretched separator, with a stretching ratio of 2.5 times and a stretching temperature of 130 [symbol] , and then S7 SBS stretching was performed with a stretching ratio of 3×3 times and a stretching temperature of 130 [symbol] .

Dichloromethane was used as the extractant to extract the white oil by stages in S8, with the extraction time of 30 min; and S9 TD3 stretching was performed on the separator after extraction, with a stretching ratio of 1.2 times, and a stretching temperature of 130 [symbol] .

S10 heat setting was performed on the separator stretched in S9 TD3, with a heat setting temperature of 135 [symbol] , to obtain an ultrahigh strength polyethylene separator.

### COMPARATIVE EXAMPLE 2

The blending of the same raw materials and the S1 extrusion were completed by the same steps as in Example 2; after S2 piece forming, only S3 MD1 and S4 TD1 stretching at the same temperature and stretching ratio were performed; and then S8 extraction was performed under the same conditions; after extraction, S6 TD2 stretching at the same temperature and stretching ratio as those of S9 TD3 in Example 2 was performed; and then S10 heat setting was performed at the same temperature and time as those in Example 2 to obtain a comparative sample.

The test results of the separator products prepared in Example 2 and Comparative Example 2 are as follows:

| | Example 2 | Comparative Example 2 |
|---|---|---|
| Thickness (μm) | 5.5 | 6.8 |
| Total puncture strength (gf) | 631 | 434 |
| Puncture strength/thickness (gf/μm) | 114.7 | 63.8 |
| MD tensile strength (kgf/cm²) | 6250 | 3350 |
| TD tensile strength (kgf/cm²) | 5850 | 3450 |

### EXAMPLE 3

100 parts of high-molecular-weight polyethylene (average molecular weight 600,000) and 0.5 part of antioxidant were blended and stirred into a mixture; then the mixture was poured into the feed bin of an extruder and 300 parts of white oil were added at the same time, the screw and extrusion rate were adjusted to make the high-molecular-weight polyethylene and the white oil be fully mixed and plasticized, S1 extrusion was performed through the die; and S2 cooling and piece forming was performed on the chill rolls.

S3 MD1 stretching and S4 TD1 stretching were performed sequentially on the casting piece, in which the stretching ratio was both 10 times, the stretching temperature of S3 MD1 was 120 [symbol] , and the stretching temperature of S4 TD was 125 [symbol] .

S5 MD2 stretching was performed on the stretched separator, with a stretching ratio of 2.5 times and a stretching temperature of 130 [symbol] , and then S7 SBS stretching was performed, with a stretching ratio of 5×5 times and a stretching temperature of 130 [symbol] .

Dichloromethane was used as the extractant to extract the white oil by stages in S8, with the extraction time of 30 min; and S9 TD3 stretching was performed on the separator after extraction, with a stretching ratio of 1.2 times, and a stretching temperature of 130 [symbol] .

S10 heat setting on the separator stretched in S9 TD3 was performed, with a heat setting temperature of 135 [symbol] , to obtain an ultrahigh strength polyethylene separator.

### COMPARATIVE EXAMPLE 3

The blending of the same raw materials and the S1 extrusion were completed by the same steps as in Example 3; only S3 MD1 and S4 TD1 stretching were performed at the same temperature and stretching ratio after S2 piece forming; and then S8 extraction was performed under the same conditions; after extraction, S6 TD2 stretching was performed at the same temperature and stretching ratio as those of S9 TD3 in Example 3; and then S10 heat setting was performed at the same temperature and time as those in Example 3 to obtain a comparative sample.

The test results of the separator products prepared in Example 3 and Comparative Example 3 are as follows:

| | Example 3 | Comparative Example 3 |
|---|---|---|
| Thickness (μm) | 5.2 | 6.6 |
| Total puncture strength (gf) | 625 | 456 |
| Puncture strength/thickness (gf/μm) | 120.2 | 69.1 |
| MD tensile strength (kgf/cm²) | 6500 | 3800 |
| TD tensile strength (kgf/cm2) | 6150 | 3950 |

### EXAMPLE 4

100 parts of high-molecular-weight polyethylene (average molecular weight 600,000) and 0.5 part of antioxidant were blended and stirred into a mixture; then the mixture was poured into the feed bin of an extruder and 300 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were sequentially performed on the casting piece, wherein the stretching ratio was both 8 times, the stretching temperature of S3 MD1 was 120 [symbol] , and the stretching temperature of S4 TD1 was 125 [symbol] .

S5 MD2 stretching was performed on the stretched separator, with a stretching ratio of 2 times and a stretching temperature of 130 [symbol] ; and then S7 SBS stretching was performed, with a stretching ratio of 8×8 times and a stretching temperature of 130 [symbol] .

Dichloromethane was used as the extractant to extract the white oil by stages in S8, with the extraction time of 30 min; and S9 TD3 stretching was performed on the separator after extraction, with a stretching ratio of 1.2 times, and a stretching temperature of 130 [symbol] .

S10 heat setting was performed on the separator stretched in S9 TD3, with a heat setting temperature of 135 [symbol] , to obtain an ultrahigh strength polyethylene separator.

### COMPARATIVE EXAMPLE 4

The blending of the same raw materials and the S1 extrusion by the same steps were performed as in Example 4; after S2 piece forming, only S3 MD1 and S4 TD1 stretching at the same temperature and stretching ratio were performed; and then S8 extraction under the same conditions was performed; after extraction, S6 TD2 stretching at the same temperature and stretching ratio were performed as those of S9 TD3 in Example 4; and then S10 heat setting was performed at the same temperature and time as those in Example 4 to obtain a comparative sample.

The test results of the separator products prepared in Example 4 and

Comparative Example 4 are as follows:

| | Example 4 | Comparative Example 4 |
|---|---|---|
| Thickness (μm) | 4.8 | 6.6 |
| Total puncture strength (gf) | 602 | 447 |
| Puncture strength/thickness (gf/μm) | 125.4 | 67.7 |
| MD tensile strength (kgf/cm²) | 6880 | 3630 |
| TD tensile strength (kgf/cm²) | 6470 | 3880 |

### EXAMPLE 5

100 parts of high-molecular-weight polyethylene (average molecular weight 600,000) and 0.5 part of antioxidant were blended and stirred into a mixture; then the mixture was poured into the feed bin of an extruder and 300 parts of white oil were added at the same time; the screw and extrusion rate were adjusted to make the high-molecular-weight polyethylene and the white oil be fully mixed and plasticized; S1 extrusion was performed through the die; and S2 cooling and piece forming were performed on the chill rolls.

S3 MD1 stretching and S4 TD1 stretching were performed sequentially on the casting piece, wherein the stretching ratio was both 10 times, the stretching temperature of S3 MD1 was 120 [symbol] , and the stretching temperature of S4 TD1 was 125 [symbol] .

S5 MD2 stretching was performed on the stretched separator, with a stretching ratio of 10 times and a stretching temperature of 130 [symbol] ; and then S6 TD2 stretching was performed, with a stretching ratio of 10 times and a stretching temperature of 130 [symbol] .

Dichloromethane was used as the extractant to extract the white oil by stages in S8, with the extraction time of 30 min; and S9 TD3 stretching was then performed on the separator after extraction, with a stretching ratio of 1.2 times, and a stretching temperature of 130 [symbol] .

S10 heat setting was performed on the separator stretched in S9 TD3, with a heat setting temperature of 135 [symbol] , to obtain an ultrahigh strength polyethylene separator.

### COMPARATIVE EXAMPLE 5

The blending of the same raw materials and the S1 extrusion were completed by the same steps as in Example 5; after S2 piece forming, only S3 MD1 and S4 TD1 stretching were performed at the same temperature and stretching ratio; and then perform S8 extraction under the same conditions; after extraction, S6 TD2 stretching was performed at the same temperature and stretching ratio as those of S9 TD3 in Example 5; and then S10 heat setting was performed at the same temperature and time as those in Example 5 to obtain a comparative sample.

The test results of the separator products prepared in Example 5 and Comparative Example 5 are as follows:

| | Example 5 | Comparative Example 5 |
|---|---|---|
| Thickness (μm) | 4.6 | 6.6 |
| Total puncture strength (gf) | 595 | 447 |
| Puncture strength/thickness (gf/μm) | 129.3 | 67.7 |
| MD tensile strength (kgf/cm²) | 6480 | 3630 |
| TD tensile strength (kgf/cm²) | 6880 | 3880 |

### EXAMPLE 6

100 parts of high-molecular-weight polyethylene (average molecular weight 600,000) and 0.5 part of antioxidant were blended and stirred into a mixture; then the mixture was poured into the feed bin of an extruder and 300 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were sequentially performed on the casting piece, wherein the stretching ratio of MD1 was 7.5 times, the stretching ratio of TD1 was 15 times, the stretching temperature of S3 MD1 was 120 [symbol] , and the stretching temperature of S4 TD1 was 125 [symbol] .

S5 MD2 stretching was performed on the stretched separator, with a stretching ratio of 2 times and a stretching temperature of 130 [symbol] ; and then S7 SBS stretching was performed, with a stretching ratio of 10×10 times and a stretching temperature of 130 [symbol] .

Dichloromethane was used as the extractant to extract the white oil by stages in S8, with the extraction time of 30 min; and S9 TD3 stretching was performed on the separator after extraction, with a stretching ratio of 1.2 times, and a stretching temperature of 130 [symbol] .

S10 heat setting was performed on the separator stretched in S9 TD3, with a heat setting temperature of 135 [symbol] , to obtain an ultrahigh strength polyethylene separator.

### COMPARATIVE EXAMPLE 6

The blending of the same raw materials and the S1 extrusion were performed by the same steps as in Example 6; after S2 piece forming, only S3 MD1 and S4 TD1 stretching were performed at the same temperature and stretching ratio; and then S8 extraction was performed under the same conditions; after extraction, S6 TD2 stretching was performed at the same temperature and stretching ratio as those of S9 TD3 in Example 6; and then S10 heat setting was performed at the same temperature and time as those in Example 6 to obtain a comparative sample.

The test results of the separator products prepared in Example 6 and Comparative Example 6 are as follows:

| | Example 6 | Comparative Example 6 |
|---|---|---|
| Thickness (μm) | 3.8 | 7.1 |
| Total puncture strength (gf) | 649 | 478 |
| Puncture strength/thickness (gf/μm) | 166.5 | 67.3 |
| MD tensile strength (kgf/cm²) | 6780 | 3150 |
| TD tensile strength (kgf/cm²) | 6920 | 3850 |

### EXAMPLE 7

100 parts of high-molecular-weight polyethylene (average molecular weight 1,500,000) and 0.5 part of antioxidant were blended and stirred into a mixture; then the mixture was poured into the feed bin of an extruder and 300 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were sequentially performed on the casting piece, wherein the stretching ratio was both 15 times, the stretching temperature of S3 MD1 was 120 [symbol] , and the stretching temperature of S4 TD1 was 125 [symbol] .

S5 MD2 stretching was performed on the stretched separator, with a stretching ratio of 10 times and a stretching temperature of 130 [symbol] ; and then S6 TD2 stretching was performed, with a stretching ratio of 10 times and a stretching temperature of 130 [symbol] .

Dichloromethane was used as the extractant to extract the white oil by stages in S8, with the extraction time of 30 min; and S9 TD3 stretching was performed on the separator after extraction, with a stretching ratio of 1.2 times, and a stretching temperature of 130 [symbol] .

S10 heat setting was performed on the separator stretched in S9 TD3, with a heat setting temperature of 135 [symbol] , to obtain an ultrahigh strength polyethylene separator.

### COMPARATIVE EXAMPLE 7

The blending of the same raw materials and the S1 extrusion were completed by the same steps as in Example 7; after S2 piece forming, only S3 MD1 and S4 TD1 stretching at the same temperature and stretching ratio were performed; and then S8 extraction was performed under the same conditions; after extraction, S6 TD2 stretching was performed at the same temperature and stretching ratio as those of S9 TD3 in Example 7; and then S10 heat setting was performed at the same temperature and time as those in Example 7 to obtain a comparative sample.

The test results of the separator products prepared in Example 7 and Comparative Example 7 are as follows:

| | Example 7 | Comparative Example 7 |
|---|---|---|
| Thickness (μm) | 3.7 | 6.4 |
| Total puncture strength (gf) | 705 | 464 |
| Puncture strength/thickness (gf/μm) | 190.5 | 72.5 |
| MD tensile strength (kgf/cm²) | 6880 | 3890 |
| TD tensile strength (kgf/cm²) | 6950 | 4050 |

1. An ultrahigh strength separator, wherein the thickness of the ultrahigh strength separator ranges from 3.7 μm to 8 μm, the transverse-direction tensile strength of the ultrahigh strength separator is greater than 4000 kgf/cm², the machine-direction tensile strength of the ultrahigh strength separator is greater than 4000 kgf/cm², and the puncture strength per thickness of the ultrahigh strength separator is no less than 100 gf/μm.

2. The ultrahigh strength separator according to claim 1, wherein the transverse-direction tensile strength of the ultrahigh strength separator ranges from 4500 kgf/cm² to 7000 kgf/cm², the machine-direction tensile strength of the ultrahigh strength separator ranges from 4500 kgf/cm² to 7000 kgf/cm², and/or the puncture strength per thickness of the ultrahigh strength separator ranges from 100 gf/μm to 200 gf/μm.

3. The ultrahigh strength separator according to claim 1, wherein the porosity of the ultrahigh strength separator ranges from 30% to 50%, and/or the air permeability of the ultrahigh strength separator ranges from 50 s/100 ml to 300 s/100 ml.

4. A method for preparation of an ultrahigh strength separator, comprising:
(1) mixing and heating a composition comprising a polyolefin resin, an antioxidant, and a pore-forming agent to form a molten state mixture, extruding the mixture through a die, and then cooling it to form a casting piece;
(2) performing a first machine direction stretching and a first transverse direction stretching on the casting piece sequentially to obtain a stretched film;
(3) performing a second machine direction stretching on the stretched film;
(4) performing a second transverse direction stretching;
(5) performing extraction, a third transverse stretching, and heat setting sequentially to obtain the ultrahigh strength separator.

5. The method for preparation of an ultrahigh strength separator according to claim 4, wherein when performing the second transverse direction stretching in step (4), the stretching temperature ranges from 90° C. to 140° C., and the stretching ratio ranges from 2 to 10 times.

6. A method for preparation of an ultrahigh strength separator, comprising:
(1) mixing and heating a composition comprising a polyolefin resin, an antioxidant, and a pore-forming agent to form a molten state mixture, extruding the mixture through a die, and then cooling it to form a casting piece;
(2) performing a first machine direction stretching and a first transverse direction stretching on the casting piece sequentially to obtain a stretched film;
(3) performing a second machine direction stretching on the stretched film;
(4) performing a synchronous biaxial stretching;
(5) performing extraction, a third transverse stretching, and heat setting sequentially to obtain the ultrahigh strength separator.

7. The method for preparation of an ultrahigh strength separator according to claim 6, wherein when performing the synchronous biaxial stretching in step (4), the stretching temperature ranges from 90° C. to 140° C., and the stretching ratio ranges from 1.5×1.5 to 12×12 times.

8. The method for preparation of an ultrahigh strength separator according to claim 4, wherein for both the first machine direction stretching and the first transverse direction stretching in step (2), the stretching temperature ranges from 60° C. to 150° C., and the stretching ratio ranges from 3 to 15 times.

9. The method for preparation of an ultrahigh strength separator according to claim 4, wherein for the second machine direction stretching in step (3), the stretching temperature ranges from 60° C. to 140° C., and the stretching ratio ranges from 2 to 10 times.

10. The method for preparation of an ultrahigh strength separator according to claim 4, wherein for the third transverse direction stretching in step (5), the stretching temperature ranges from 100° C. to 150° C., and the stretching ratio ranges from 1.1 to 2 times.

11. The method for preparation of an ultrahigh strength separator according to claim 4, wherein the temperature of heat setting in step (5) ranges from 110° C. to 150° C.

12. The method for preparation of an ultrahigh strength separator according to claim 4, wherein the polyolefin resin in step (1) is a high-molecular-weight polyethylene, and the molecular weight of the polyethylene ranges from 600,000 to 2,000,000.

13. The method for preparation of an ultrahigh strength separator according to claim 4, wherein the antioxidant in step (1) is one or more selected from amines, sulfur-containing compounds, nitrogen-containing compounds, phosphorus-containing compounds, and organic metal salts.

14. The method for preparation of an ultrahigh strength separator according to claim 4, wherein the pore-forming agent in step (1) is one or more selected from white oil, paraffin oil, and polyethylene glycol.

15. The method for preparation of an ultrahigh strength separator according to claim 6, wherein for both the first machine direction stretching and the first transverse direction stretching in step (2), the stretching temperature ranges from 60° C. to 150° C., and the stretching ratio ranges from 3 to 15 times.

16. The method for preparation of an ultrahigh strength separator according to claim 6, wherein for the second machine direction stretching in step (3), the stretching temperature ranges from 60° C. to 140° C., and the stretching ratio ranges from 2 to 10 times.

17. The method for preparation of an ultrahigh strength separator according to claim 6, wherein for the third transverse direction stretching in step (5), the stretching temperature ranges from 100° C. to 150° C., and the stretching ratio ranges from 1.1 to 2 times.

18. The method for preparation of an ultrahigh strength separator according to claim 6, wherein the temperature of heat setting in step (5) ranges from 110° C. to 150° C.

19. The method for preparation of an ultrahigh strength separator according to claim 6, wherein the polyolefin resin in step (1) is a high-molecular-weight polyethylene, and the molecular weight of the polyethylene ranges from 600,000 to 2,000,000.

20. The method for preparation of an ultrahigh strength separator according to claim 6, wherein the antioxidant in step (1) is one or more selected from amines, sulfur-containing compounds, nitrogen-containing compounds, phosphorus-containing compounds, and organic metal salts.

21. The method for preparation of an ultrahigh strength separator according to claim 6, wherein the pore-forming agent in step (1) is one or more selected from white oil, paraffin oil, and polyethylene glycol.
